(19) United States
(12) Patent Application Publication
(10) Pub. No.: US 2025/0356777 A1
(43) Pub. Date: Nov. 20, 2025

(54) LEARNING SUPPORT SYSTEM, LEARNING SUPPORT METHOD AND STORAGE MEDIUM

(71) Applicant: CASIO COMPUTER CO., LTD., Tokyo (JP)

(72) Inventor: Yunosuke AZUMA, Tokyo (JP)

(73) Assignee: CASIO COMPUTER CO., LTD., Tokyo (JP)

(21) Appl. No.: 19/197,791

(22) Filed: May 2, 2025

(30) Foreign Application Priority Data
May 17, 2024 (JP) 2024-080787

(51) Int. Cl. G09B 7/02; G06F 3/04883

(52) U.S. Cl. CPC G09B 7/02; G06F 3/04883

(57) ABSTRACT

A learning support system includes, an operator; a display; and at least one processor. The at least one processor obtains timekeeping information in a case in which an answerer inputs by handwriting through the operator an answer including a mathematical formula or a chemical formula in a step-by-step answer process leading to a final answer. In a case in which the answer handwritten by the answerer is displayed on the display as a handwritten input image, the at least one processor controls the display to display a length of a duration required for the answerer to input by handwriting the answer process in a state associated with each step of the answer process.

### CROSS-REFERENCE TO RELATED APPLICATIONS

This application is based upon and claims the benefit of priority under 35 USC 119 of Japanese Patent Application No. 2024-80787, filed on May 17, 2024, entire disclosure of which, including the description, claims, drawings, and abstract, is incorporated herein by reference in its entirety.

### BACKGROUND OF THE INVENTION

### Field of the Invention

The present disclosure relates to a learning support system, a learning support method, and a storage medium.

### Description of the Related Art

Japanese Patent Laid-Open Publication No. 2012-198301 discloses a learning support device that measures answering duration for each answer field in a written test in order to evaluate a learner's level of understanding and proficiency.

### SUMMARY

A learning support system according to the present disclosure includes:
an operator;
a display; and
at least one processor,
wherein,
the at least one processor obtains timekeeping information in a case in which an answerer inputs by handwriting through the operator an answer including a mathematical formula or a chemical formula in a step-by-step answer process leading to a final answer,
in a case in which the answer handwritten by the answerer is displayed on the display as a handwritten input image, the at least one processor controls the display to display a length of a duration required for the answerer to input by handwriting the answer process in a state associated with each step of the answer process.

A learning support method according to the present disclosure is implemented by a computer, the method including:
controlling obtaining timekeeping information in a case in which an answerer inputs by handwriting through an operator an answer including a mathematical formula or a chemical formula in a step-by-step answer process leading to a final answer; and
in a case in which the answer handwritten by the answerer is displayed on a display as a handwritten input image, controlling displaying by generating data to display a length of a duration required for the answerer to input by handwriting the answer process in a state associated with each step of the answer process.

A non-transitory computer-readable storage medium according to the present disclosure stores a program that can be read by a computer of a learning support system, the program that causes the computer to perform,
controlling obtaining timekeeping information in a case in which an answerer inputs by handwriting through an operator an answer including a mathematical formula or a chemical formula in a step-by-step answer process leading to a final answer; and
in a case in which the answer handwritten by the answerer is displayed on a display as a handwritten input image, controlling displaying by generating data to display a length of a duration required for the answerer to input by handwriting the answer process in a state associated with each step of the answer process.

### BRIEF DESCRIPTION OF THE DRAWINGS

FIG. 1 is a schematic diagram of a learning support system.

FIG. 2 is a block diagram showing a functional configuration of a server.

FIG. 3 is a block diagram showing a functional configuration of a terminal device.

FIG. 4 is a flowchart showing a control procedure of a history recording process.

FIG. 5 is a diagram showing an example of a notebook screen on which a sticky note is arranged.

FIG. 6 is a diagram showing an example of a notebook screen on which a sticky note is arranged.

FIG. 7 is a diagram showing an example of an answer field provided with ruled lines.

FIG. 8 is a flowchart showing a control procedure of a display control process.

FIG. 9 is a diagram showing an example of a sticky note that displays a question and an answer to the question.

FIG. 10 is a diagram showing an example of the sticky note that displays the question and the answer to the question.

### DETAILED DESCRIPTION OF THE PREFERRED EMBODIMENTS

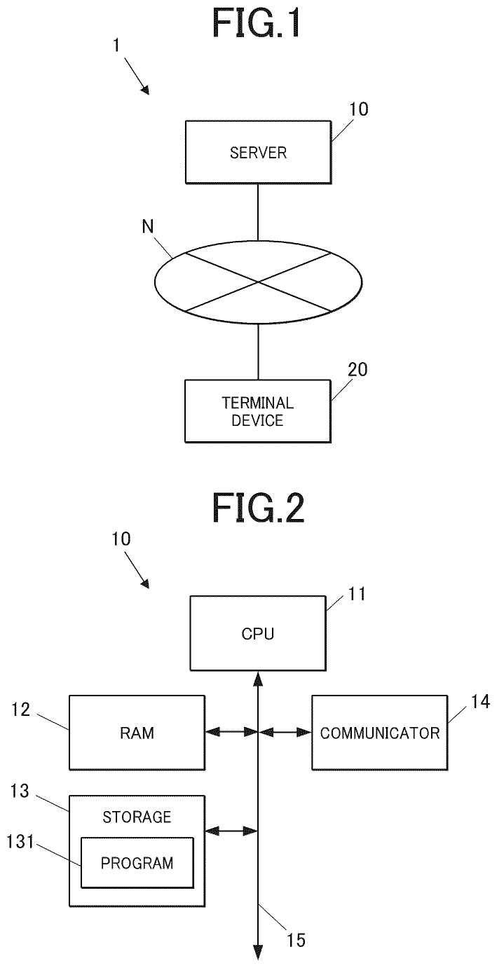

Hereinafter, embodiments of the present disclosure are described with reference to the drawings. First, a configuration according to the present embodiment will be described with reference to FIG. 1. As shown in FIG. 1, the learning support system 1 includes a server (learning support device) 10 and a terminal device 20. The server 10 is connected to the terminal device 20 via a communication network N so as to be able to communicate information. Although one terminal device 20 is shown in FIG. 1, the number of terminal devices 20 is not particularly limited. The server 10 is for providing a cloud-based learning support service. The server 10 is capable of providing, as a learning support service, a digital note function, a lesson support function, and the like, for example. The terminal device 20 is a terminal device used by a user (for example, a teacher or a student) who uses the above-mentioned learning support service. In the following description, the terminal device 20 is assumed to be a tablet PC (Personal Computer), but may be a desktop PC, a notebook PC, a smartphone, or the like. The communication network N is, for example, the Internet, but may be another network such as a LAN (Local Area Network).

Next, the functional configuration of the server 10 will be described with reference to FIG. 2. As shown in FIG. 2, the server 10 includes a Central Processing Unit (CPU) 11, a Random Access Memory (RAM) 12, a storage 13, a communicator 14, a bus 15, and the like. Each part of the server 10 is connected via the bus 15. Note that the server 10 may further include an operator, a display, and the like used by an administrator, etc. of the server 10. The CPU 11 is a processor that controls the operation of each part of the server 10 by reading and executing a program 131 stored in the storage 13 and performing various arithmetic processes. Although a single CPU 11 is illustrated in FIG. 2, the present disclosure is not limited to this. Two or more processors such as CPUs may be provided, and the processing executed by the CPU 11 of the present embodiment may be shared and executed by these two or more processors. The RAM 12 provides a working memory space for the CPU 11 and stores temporary data. The communicator 14 performs communication operations in accordance with a predetermined communication standard. Through this communication operation, the communicator 14 transmits and receives information to and from the terminal device 20 via the communication network N.

The storage 13 is a non-transitory storage medium that can be read by the CPU 11 as the computer, and stores the program 131 and various data. The program 131 is stored in the storage 13 in a form of a program code that can be read by the computer. The storage 13 also stores a user database (not shown) that stores user information (user ID, password, basic information, etc.) related to users who use the learning support service. The storage 13 also stores notebook management information for managing information related to a notebook created by the user in the digital note function. The storage 13 stores notebook management information for each user. The digital note function allows the user to create the sticky note and place the sticky note in the notebook.

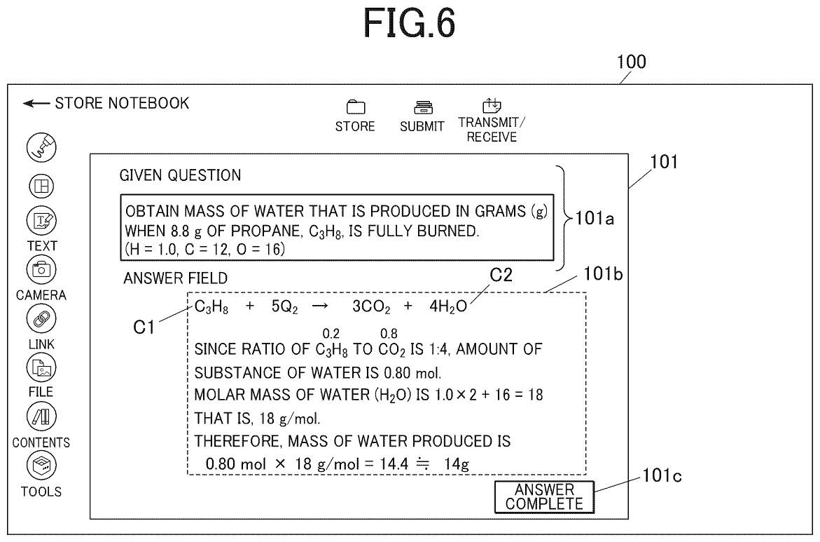

In the example of the notebook screen 100 displaying a notebook shown in FIGS. 5 and 6, a sticky note 101 is placed on the notebook. The notebook is a notebook-type WEB component (digital component) that is a display element displayed on the display 25 of the terminal device 20. The sticky note is a WEB component to record learning items in various ways. Here, an example will be described in which the sticky note has a substantially rectangular shape, but the shape is not limited to this. The shape and size of the sticky note are such that it can be placed on the notebook. The user can move the sticky note placed on the notebook to any position within the notebook via the operator 24 of the terminal device 20.

The notebook management information includes identification information of a target notebook, identification information of the sticky note placed in the notebook, coordinate information of the sticky note in the notebook, and the like, and the above information are associated with one another. Furthermore, the storage 13 also stores sticky note management information for managing information related to the sticky note created by the user in the digital note function. The sticky note management information includes information such as identification information of a target sticky note, a type of sticky note, and contents of the sticky note. The type of sticky note is information indicating the type corresponded to the sticky note, such as a text sticky note, a camera sticky note, a link sticky note, a file sticky note, a content sticky note, or a tool sticky note. The sticky note content indicates the content of the sticky note, and is information that indicates in an identifiable manner a character string, an image, a video, or the like. The sticky note contents also include information regarding display settings such as display size and background color of the sticky note.

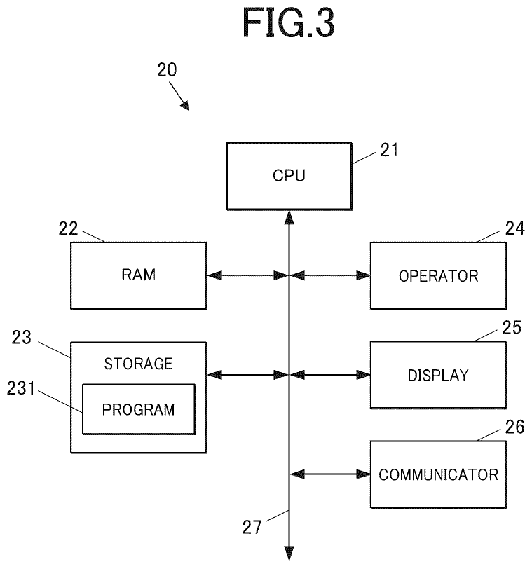

Next, the functional configuration of the terminal device 20 will be described with reference to FIG. 3. As shown in FIG. 3, the terminal device 20 includes a CPU 21, a RAM 22, a storage 23, an operator 24, a display 25, a communicator 26, a bus 27, and the like. Each part of the terminal device 20 is connected via the bus 27. The CPU 21 is a processor that controls the operation of each part of the terminal device 20 by reading and executing the program 231 stored in the storage 23 and performing various arithmetic processes. The RAM 22 provides a working memory space for the CPU 21 and stores temporary data.

The storage 23 is a non-transitory storage medium that can be read by the CPU 21 as a computer, and stores the program 231 and various data. The program 231 is stored in the storage 23 in the form of a program code that can be read by the computer. The operator 24 accepts an input operation by the user and outputs an input signal corresponding to the input operation to the CPU 21. The operator 24 includes a touch screen that is provided overlaid on the display screen of the display 25, and senses contact with a stylus, a user's finger, or the like as the input operation by using this touch screen. The operator 24 may be provided with hardware buttons in addition to or instead of the touch screen, and may be capable of accepting input operation via these hardware buttons. The display 25, under the control of the CPU 21, displays a notebook screen 100 (see FIGS. 5 and 6) and the like. The display 25 may be, for example, a liquid crystal display device that performs display using a dot matrix method, but is not limited to this. The communicator 26 performs communication operations in accordance with a predetermined communication standard. Through this communication operation, the communicator 26 transmits and receives information to and from the server 10 via the communication network N.

Next, the operation of the learning support system 1 will be described. The server 10 performs login authentication for users who use the learning support service. Specifically, in the terminal device 20, a command to execute a browser is input from the user via the operator 24, which triggers the CPU 21 to execute the browser. Then, the user inputting a Uniform Resource Locator (URL) of a WEB page of the learning support service of the server 10 via the operator 24 on the terminal device 20 running a browser acts as a trigger, and the CPU 21 uses the input URL to send a login request from the user to the server 10 via the communicator 26. In the server 10, in response to the CPU 11 receiving a login request from the terminal device 20 via the communicator 14, the CPU 11 generates login screen data and transmits the data to the terminal device 20 that has made the request. In the terminal device 20, the CPU 21 receives the login screen data from the server 10 via the communicator 26 and displays the login screen data on the display 25. Then, the CPU 21 accepts input of a user ID and password from the user via the operator 24, and transmits the input user ID and password to the server 10 via the communicator 26. In the server 10, in response to the CPU 11 receiving the user ID and password from the terminal device 20 via the communicator 14, the CPU 11 performs login authentication of the user using the received user ID and password. In response to the login authentication of the user succeeding, the CPU 11 provides the learning support service to the terminal device 20. The terminal device 20 realizes the learning support service on the browser. In the learning support service, the CPU 11 accepts input of operation information from the user via the operator 24, and provides a digital note function, a lesson support function, and the like in accordance with the input operation information. The CPU 11 of the server 10 activates the digital note function, which is a type of learning support service, in the terminal device 20 based on predetermined operation performed on the operator 24 of the terminal device 20. Then, the CPU 11 causes the display 25 of the terminal device 20 to display the notebook screen 100 based on the notebook management information and sticky note management information stored in the storage 13 with the user ID of the user whose login is authenticated.

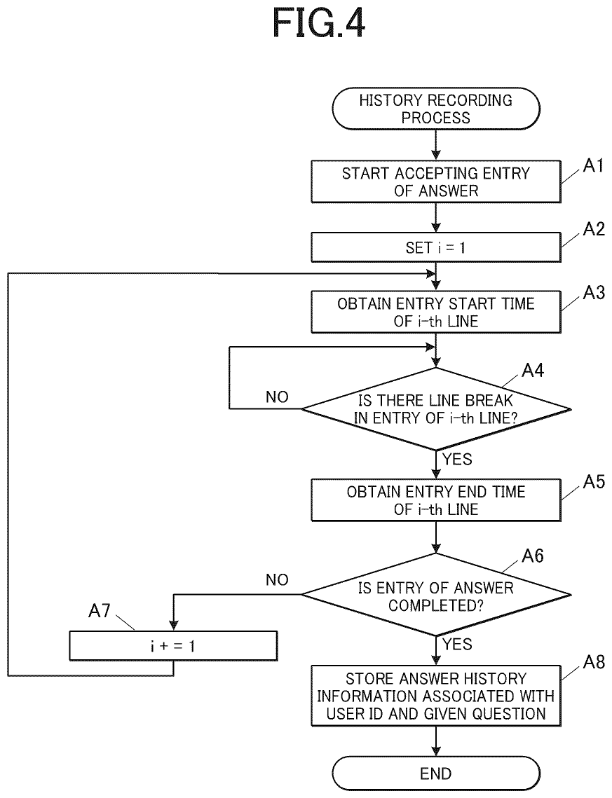

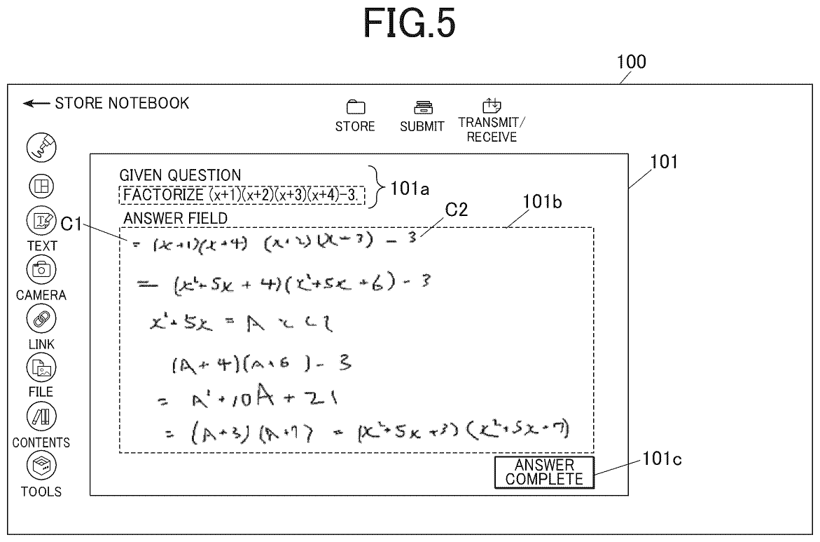

Next, a history recording process shown in FIG. 4 and executed by the server 10 will be described. The CPU 11 of the server 10 executes a history recording process in response to accepting a learning start instruction from the user via the operator 24 to start studying for a question that requires a step-by-step answer process leading up to a final answer to be included in contents of the answer. That is, the CPU 11 of the server 10 executes the history recording process in response to accepting the learning start instruction from the user via the operator. Such learning instruction is an instruction to start studying about a question that requires the contents of the answer to include the step-by-step answer process leading to the final answer by the user. It should be noted that the step-by-step answer process includes a formula. The formula may be, for example, a mathematical formula or a chemical formula.

In response to starting the history recording process, first, the CPU 11 of the server 10 performs the following process of displaying the sticky note 101 on the notebook screen 100 as shown in FIGS. 5 and 6. Specifically, the CPU 11 of the server 10 generates data to display the sticky note 101 on the notebook screen 100 and transmits the generated data to the terminal device 20. Then, the CPU 21 of the terminal device 20 displays the sticky note 101 on the notebook screen 100 based on the transmitted data. In the following description, for the ease of description, a description regarding generating data for such display control and transmission and reception of such data will be omitted, and the description will be given assuming that the CPU 11 is mainly responsible for the operation of display.

The CPU 11 causes the sticky note 101 to display a given question 101a and an answer field 101b for entering the answer to the given question 101a. Here, in the examples of FIGS. 5 and 6, the answer field 101b is shown in a state in which the answer has already been written, but initially it is displayed in a blank state. Next, the CPU 11 starts accepting an entry of the answer to the given question by handwriting input from the user via the operator 24 in the answer field 101b (step A1). Next, the CPU 11 sets a variable i, which indicates a number of lines in the answer, to i=1 (step A2). Next, the CPU 11 obtains entry start time (time of day) which is when an entry of the i-th line is started in the answer field 101b (step A3). In step A3 performed for the first time, the CPU 11 obtains the entry start time of a first line in the answer field 101b. Specifically, the CPU 11 obtains the time when the entry of the first character C1 on the first line in the answer field 101b starts.

Next, the CPU 11 judges whether or not there is a line break in the entry of the i-th line in the answer field 101b. With this, the CPU 11 judges whether or not the entry of the i-th line in the answer field 101b is completed (step A4). In other words, the CPU 11 judges that a step of the answer process has transitioned to the next step at each line break in the answer. If the entry of the i-th line is not completed (step A4; NO), the CPU 11 returns the history recording process to step A4. On the other hand, if the entry of the i-th line is completed (step A4; YES), the CPU 11 obtains entry end time which is when the entry of the i-th line in the answer field 101b is completed (step A5). In step A5 performed for the first time, the CPU 11 obtains the entry end time of the first line in the answer field 101b. Specifically, the CPU 11 obtains the time when the entry of a last character C2 on the first line in the answer field 101b is completed.

Next, the CPU 11 judges whether or not the entry of the answer to the given question in the answer field 101b is completed (step A6). Specifically, the CPU 11 judges whether or not an answer end button 101c provided on the sticky note 101 is pressed by the user. This is a case in which the answer entry is not completed (step A6; NO), that is, the answer end button 101c is not pressed. In this case, the CPU 11 increments the variable i, which indicates the number of lines in the answer, by 1 (step A7), and advances the history recording process to step A3. In step A7 performed for the first time, the CPU 11 sets i=2. On the other hand, in a case in which the answer entry is completed (step A6; YES), this is, in other words, the case in which the answer end button 101c is pressed. In this case, the CPU 11 stores the login user ID with which the login process is authenticated, the given question, and answer history information in association with each other in the storage 13 (step A8), and ends the history recording process. The answer history information includes the answer entered by the user in the answer field 101b, and the entry start time and entry end time for each line of the answer.

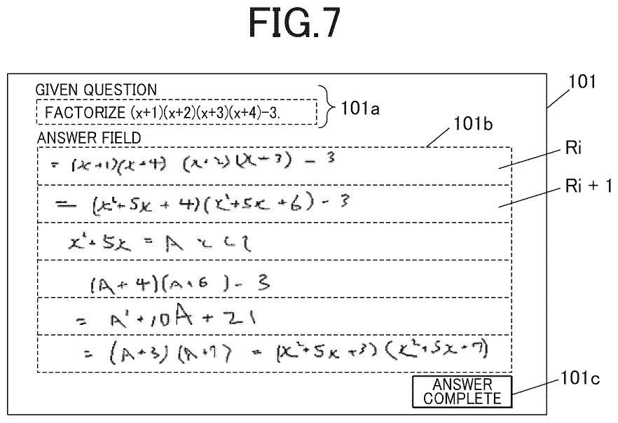

As shown in FIG. 7, the answer field 101b of the sticky note 101 may be ruled. In this case, in response to a region in which the user inputs the answer shifting from a region Ri on the i-th line to a region Ri+1 on the i+1-th line in step A4 of the history recording process, the CPU 11 judges that the entry into the i-th line in the answer field 101b has been completed. In addition, in the history recording process, the CPU 11 may calculate a duration that the user needed to enter each line based on coordinates and time information of a route handwritten by the user from the start of entering the first line of the answer to the end of entering the last line. Furthermore, a final answer field (not shown) may be provided in the answer field 101b of the sticky note 101. In this case, in response to the user entering the answer in the final answer field in step A6 of the history recording process, the CPU 11 judges that the entry of the answer to the given question in the answer field 101b is complete.

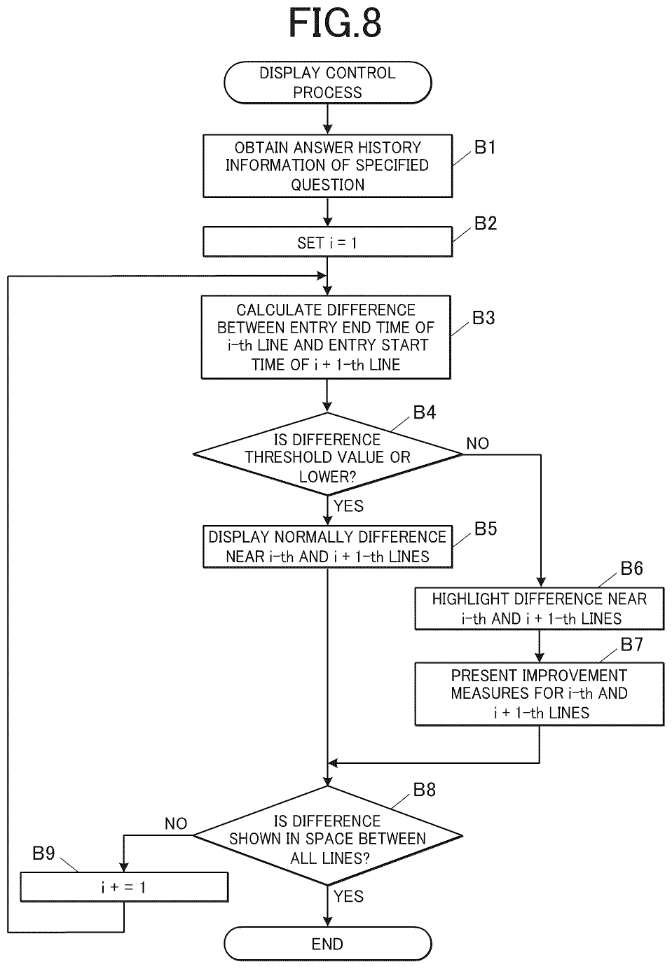

Next, a display control process shown in FIG. 8 and executed by the server 10 will be described. The CPU 11 starts the display control process, for example, the trigger being accepting an instruction to display the answer to the question that a predetermined user answered with predetermined operation on the operator 24 of the terminal device 20.

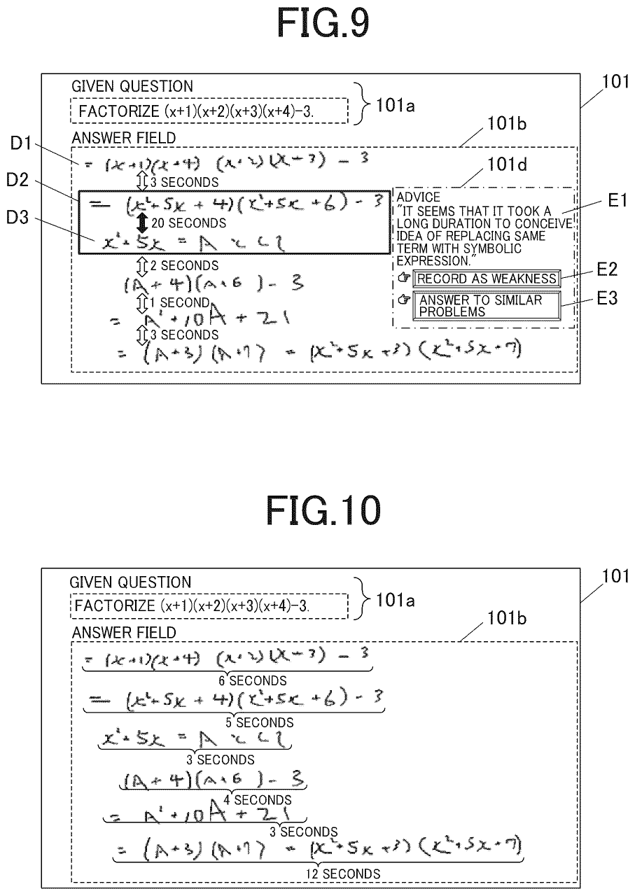

In response to the display control process starting, first, the CPU 11 of the server 10 obtains from the storage 13 the answer history information of the question (specified question) that is associated with the user ID with which the login has been authenticated and that the user instructed through the operator 24 for the answer to be displayed (step B1). Next, the CPU 11 sets the variable i, which indicates the number of lines in the answer, to i=1 (step B2). Next, the CPU 11 calculates the difference between the entry end time of the i-th line and the entry start time of the i+1-th line included in the answer history information (step B3). In step B3 performed for the first time, the CPU 11 calculates the difference between the entry end time on the first line of the answer and the entry start time on the second line of the answer. Next, the CPU 11 judges whether the difference calculated in step B3 is equal to or smaller than a preset threshold value (step B4). The threshold value is set in association with each line of the answer, and is stored in advance in the storage 13. If the difference calculated in step B3 is less than or equal to the threshold value (step B4; YES), the CPU 11 displays the specified question and the user's answer to the specified question on the sticky note 101 displayed on the display 25, and also displays the difference calculated in step B3 in the normal manner near the i-th and i+1-th lines (step B5). For example, as shown in FIG. 9, the CPU 11 displays “3 seconds”, which is the difference between the entry end time on a first line D1 and the entry start time on a second line D2, in a normal manner (e.g., in blue letters) between the first line D1 and the second line D2 of the answer field 101b of the sticky note 101.

On the other hand, if the difference calculated in step B3 is greater than the threshold value (step B4; NO), the CPU 11 displays the specified question and the user's answer to the specified question on the sticky note 101 displayed on the display 25, and highlights the difference calculated in step B3 near the i-th and i+1-th lines (step B6). For example, as shown in FIG. 9, the CPU 11 highlights “20 seconds”, which is the difference between the entry end time on the second line D2 and the entry start time on the third line D3, between the second line D2 and the third line D3 of the answer field 101b of the sticky note 101, in a different manner from the normal manner (e.g., in red). In addition, the CPU 11 displays a red frame surrounding the second line D2 and the third line D3.

In steps B5 and B6, the CPU 11 displays, based on timekeeping information in a case in which the answerer handwrites in response to the question the answer having the step-by-step answer process including a mathematical or chemical formula leading to the final answer, the length of the duration that is necessary for the answerer to handwrite a certain step for each step in the answer process in association with an image of the handwritten answer. The CPU 11 functions as a controller. Steps B5 and B6 are control steps. The timekeeping information is the entry start time and the entry end time for each line of the answer. The CPU 11 displays as the length of the duration required by the answerer to input by handwriting the step of the answer process, the length of the duration from the entry end timing of a predetermined step of the answer process to the entry start timing of the next step of the predetermined step of the answer process.

Next, the CPU 11 presents the improvement measures to the user by displaying improvement measures related to the i-th and the i+1-th lines near the i-th and the i+1-th lines (step B7). For example, as shown in FIG. 9, the CPU 11 displays an improvement measure 101d near the second line D2 and the third line D3 of the answer field 101b of the sticky note 101. The improvement measure 101d includes advice E1, a record selection button E2, and a similar question button E3. The advice E1 is advice relating to the i-th and i+1-th lines of the answer, and is stored in advance in the storage 13 in association with the i-th and i+1-th lines of the answer. In other words, if the length of the duration required by the answerer to input by handwriting the step of the answer process is longer than a predetermined threshold value that is pre-set corresponding to the stage of the answer process, the CPU 11 displays a comment (advice E1) that is pre-set corresponding to the step of the answer process in association with the image of the handwritten answer. In addition, in response to accepting pressing of the record selection button E2 via the operator 24, the CPU 11 associates the i-th and i+1-th lines of the answer with the user ID corresponding to the answer history information, and stores the above in the storage 13 as a weakness of the user indicated by the user ID. In addition, in response to accepting pressing of the similar question button E3 via the operator 24, the CPU 11 controls the display 25 to display a similar question that is associated with the i-th and i+1-th lines of the answer and that is stored in advance in the storage 13.

Next, the CPU 11 judges whether or not the differences between all lines of the answer are displayed (step B8). If the differences between all lines of the answer are displayed (step B8; YES), the CPU 11 ends the display control process. On the other hand, if the differences between all lines of the answer are not displayed (step B8; NO), the CPU 11 increments the variable i representing the number of lines in the answer by 1 (step B9) and transitions the display control process to step B3. In step B9 performed for the first time, the CPU 11 sets i=2.

In step B3 of the display control process, the CPU 11 may calculate the duration required to enter the i-th line by calculating the difference between the entry start time of the i-th line and the entry end time of the i-th line. In this case, in step B5 or B6, the CPU 11 displays the duration required to enter the i-th line near (for example, below the i-th line) the i-th line of the answer field 101b as shown in FIG. 10. In other words, the CPU 11 displays as the length of the duration required by the answerer to input by handwriting the step of the answer process, the length of the duration from the entry start timing of the predetermined step of the answer process to the entry end timing of the predetermined step of the answer process.

Furthermore, in the display control process, the CPU 11 may accept the operation to select either a first mode or a second mode via the operator 24. The CPU 11 functions as an acceptor. In response to selecting the first mode, the CPU 11 calculates the difference between the entry end time on the i-th line included in the answer history information and the entry start time on the i+1-th line, and displays the difference near the i-th line and the i+1-th line, as shown in FIG. 9. That is, the CPU 11 displays as the length of the duration required by the answerer to input by handwriting the step of the answer process, the length of the duration from the entry end timing of a predetermined step of the answer process to the entry start timing of the next step of the predetermined step of the answer process. On the other hand, in response to selecting the second mode, the CPU 11 calculates the difference between the entry start time of the i-th line included in the answer history information and the entry end time of the i-th line to calculate the duration required to enter the i-th line, and displays the duration required to enter the i-th line near the i-th line, as shown in FIG. 10. In other words, the CPU 11 displays as the length of the duration required by the answerer to input by handwriting the step of the answer process, the length of the duration from the entry start timing of the predetermined step of the answer process to the entry end timing of the predetermined step of the answer process.

Furthermore, the CPU 11 may accept a designation of a user ID for which an answer is to be displayed in the display control process. In this case, in step B1, the CPU 11 obtains from the storage 13 the answer history information of the question (specified question) to which the specified user ID is associated and that the user instructed via the operator 24 for the answer to be displayed. Furthermore, the CPU 11 may execute the following process in the display control process. Specifically, the CPU 11 compares a model answer to a question stored in advance in the storage 13 with the answer by the user included in the answer history information to determine whether the answer by the user is correct or incorrect. Then, if the answer provided by the user included in the answer history information is correct, the CPU 11 calculates the difference between the entry end time on the i-th line included in the answer history information and the entry start time on the i+1-th line, and displays the difference near the i-th line and the i+1-th line. On the other hand, if the answer by the user included in the answer history information is incorrect, the CPU 11 does not display the difference between the entry end time of the i-th line and the entry start time of the i+1-th line.

As described above, the server 10 (learning support device) according to the present embodiment includes a controller (CPU 11) that displays, based on timekeeping information in a case in which the answerer inputs by handwriting the answer to the question having the step-by-step answer process including a mathematical or chemical formula leading up to the final answer, the length of the duration that is necessary for the answerer to handwrite a certain step for each step in the answer process in association with the image of the handwritten answer. Therefore, it is possible to specify the part in the step-by-step answer process where the answerer is taking a long amount of time to enter. This makes it easier to specify the area where the answerer's understanding or proficiency is low for questions that have the step-by-step answer process, thereby identifying the answerer's tendency of the weaknesses and helping to provide effective review and instruction to the learner.

In the server 10 (learning support device) according to this embodiment, the controller (CPU 11) displays as the length of the duration required by the answerer to input by handwriting each step of the answer process the length of the duration from the entry end timing of a predetermined step of the answer process to the entry start timing of the next step of the predetermined step of the answer process. Therefore, since the duration from the entry end time on the i-th line in the answer to the entry start time on the i+1-th line can be displayed, the answerer can easily specify the part of the step-by-step answer process that takes a long amount of time to enter.

In the server 10 (learning support device) according to this embodiment, the controller (CPU 11) displays as the length of the duration required by the answerer to input by handwriting each step of the answer process the length of the duration from the entry start timing of the predetermined step of the answer process to the entry end timing of the predetermined step of the answer process. Therefore, since the duration from the entry start time of the i-th line in the answer to the entry end time of the i-th line can be displayed, the answerer can easily specify the part that is taking a long amount of time to enter in the step-by-step answer process.

The server 10 (learning support device) according to the present embodiment includes an acceptor (CPU 11) that accepts a selection of either the first mode or the second mode. In response to the controller (CPU 11) accepting the selection of the first mode with the acceptor, the controller displays as the length of the duration required by the answerer to input by handwriting each step of the answer process, the length of the duration from the entry end timing of the predetermined step of the answer process to the entry start timing of the next step of the predetermined step of the answer process. In response to the controller accepting the selection of the second mode with the acceptor, the controller displays as the length of the duration required by the answerer to input by handwriting each step of the answer process, the length of the duration from the entry start timing of the predetermined step of the answer process to the entry end timing of the predetermined step of the answer process. Thus, depending on the user's desired mode, the length of duration necessary for the answerer to handwrite each step of the answer process can be displayed.

In the server 10 (learning support device) according to this embodiment, the controller (CPU 11) judges that the step of the answer process has transitioned to the next step each time a line break occurs in the answer. The CPU 11 can therefore easily judge that the step of the answer process has transitioned to the next step.

In the server 10 (learning support device) according to this embodiment, if the length of the duration required by the answerer to input by handwriting each step of the answer process is longer than a predetermined threshold value that is pre-set to correspond to the step of the answer process, the controller (CPU 11) displays a comment that is pre-set to correspond to the step of the answer process in association with the image of the handwritten answer. Therefore, by displaying a comment such as advice for the part that is taking the answerer a long duration to enter during the step-by-step answer process, that is, the part that the answerer has difficulty entering, it is possible to help the answerer in his/her learning.

Although an embodiment of the present disclosure is described specifically above, the embodiments of the present disclosure are not limited to the above, and various modifications are possible without leaving the scope of the invention. For example, in the above embodiment, an example is disclosed in which the non-transitory storage medium of the storage 13 is used as a computer-readable medium for the program according to the present disclosure, but the present disclosure is not limited to this example. As the computer-readable medium, it is possible to apply a portable storage medium such as a flash memory or a CD-ROM. A carrier wave is also applied to the present disclosure as the medium to provide data of the program according to the present disclosure through the communication lines.

What is claimed is:

1. A learning support system comprising:
an operator;
a display; and
at least one processor,
wherein,
the at least one processor obtains timekeeping information case in which an answerer inputs by handwriting through the operator an answer including a mathematical formula or a chemical formula in a step-by-step answer process leading to a final answer,
in a case in which the answer handwritten by the answerer is displayed on the display as a handwritten input image, the at least one processor controls the display to display a length of a duration required for the answerer to input by handwriting the answer process in a state associated with each step of the answer process.

2. The learning support system according to claim 1, wherein the at least one processor displays, as the length of the duration required by the answerer, the length of the duration from an entry end timing of a predetermined step of the answer process to an entry start timing of a next step of the predetermined step of the answer process.

3. The learning support system according to claim 1, wherein the at least one processor displays, as the length of the duration required by the answerer, the length of the duration from an entry start timing of a predetermined step of the answer process to an entry end timing of the predetermined step of the answer process.

4. The learning support system according to claim 1, wherein,
in a case in which a selection of a first mode from the first mode and a second mode is accepted, the at least one processor displays, as the length of the duration required by the answerer the length of the duration from an entry end timing of a predetermined step of the answer process to an entry start timing of a next step of the predetermined step of the answer process, and
in a case in which a selection of the second mode from the first mode and the second mode is accepted, the at least one processor displays, as the length of the duration required by the answerer the length of the duration from the entry start timing of a predetermined step of the answer process to the entry end timing of the predetermined step of the answer process.

5. The learning support system according to claim 1, wherein the at least one processor judges that the step of the answer process transitioned to the next step at each line break in the answer.

6. The learning support system according to claim 1, wherein, in a case in which the length of the duration required by the answerer is longer than a threshold value that is preset corresponding to a step of the answer process, the at least one processor displays a comment that is preset corresponding to the step of the answer process in association with the handwritten input image.

7. The learning support system according to claim 1, wherein, in a case in which the answer handwritten by the answerer is displayed on the display as the handwritten input image, the at least one processor displays on the display a given question corresponding to the answer together with the answer.

8. A learning support method implemented by a computer, the method comprising:
controlling obtaining timekeeping information in a case in which an answerer inputs by handwriting through an operator an answer including a mathematical formula or a chemical formula in a step-by-step answer process leading to a final answer; and
in a case in which the answer handwritten by the answerer is displayed on a display as a handwritten input image, controlling displaying by generating data to display a length of a duration required for the answerer to input by handwriting the answer process in a state associated with each step of the answer process.

9. The learning support method according to claim 8, wherein the controlling displaying includes, generating data to display, as the length of the duration required by the answerer, the length of the duration from an entry end timing of a predetermined step of the answer process to an entry start timing of a next step of the predetermined step of the answer process.

10. The learning support method according to claim 8, wherein the controlling displaying includes, generating data to display, as the length of the duration required by the answerer, the length of the duration from an entry start timing of a predetermined step of the answer process to an entry end timing of the predetermined step of the answer process.

11. The learning support method according to claim 8, wherein the controlling displaying includes,
in a case in which a selection of a first mode from the first mode and a second mode is accepted, generating data to display, as the length of the duration required by the answerer the length of the duration from an entry end timing of a predetermined step of the answer process to an entry start timing of a next step of the predetermined step of the answer process, and
in a case in which a selection of the second mode from the first mode and the second mode is accepted, generating data to display, as the length of the duration required by the answerer the length of the duration from the entry start timing of a predetermined step of the answer process to the entry end timing of the predetermined step of the answer process.

12. The learning support method according to claim 8, wherein the controlling displaying includes, judging that the step of the answer process transitioned to the next step at each line break in the answer.

13. The learning support method according to claim 8, wherein the controlling displaying includes, in a case in which the length of the duration required by the answerer is longer than a threshold value that is preset corresponding to a step of the answer process, generating data to display a comment that is preset corresponding to the step of the answer process in association with the handwritten input image.

14. The learning support method according to claim 8, wherein the controlling displaying includes, in a case in which the answer handwritten by the answerer is displayed on the display as the handwritten input image, generating data to display on the display a given question corresponding to the answer together with the answer.

15. A non-transitory computer-readable storage medium storing a program that can be read by a computer of a learning support system, the program that causes the computer to perform,
controlling obtaining timekeeping information in a case in which an answerer inputs by handwriting through an operator an answer including a mathematical formula or a chemical formula in a step-by-step answer process leading to a final answer; and
in a case in which the answer handwritten by the answerer is displayed on a display as a handwritten input image, controlling displaying by generating data to display a length of a duration required for the answerer to input by handwriting the answer process in a state associated with each step of the answer process.

16. The storage medium according to claim 15, wherein the controlling displaying includes, generating data to display, as the length of the duration required by the answerer, the length of the duration from an entry end timing of a predetermined step of the answer process to an entry start timing of a next step of the predetermined step of the answer process.

17. The storage medium according to claim 15, wherein the controlling displaying includes, generating data to display, as the length of the duration required by the answerer, the length of the duration from an entry start timing of a predetermined step of the answer process to an entry end timing of the predetermined step of the answer process.

18. The storage medium according to claim 15, wherein the controlling displaying includes,
in a case in which a selection of a first mode from the first mode and a second mode is accepted, generating data to display, as the length of the duration required by the answerer the length of the duration from an entry end timing of a predetermined step of the answer process to an entry start timing of a next step of the predetermined step of the answer process, and
in a case in which a selection of the second mode from the first mode and the second mode is accepted, generating data to display, as the length of the duration required by the answerer the length of the duration from the entry start timing of a predetermined step of the answer process to the entry end timing of the predetermined step of the answer process.

19. The storage medium according to claim 15, wherein the controlling displaying includes, judging that the step of the answer process transitioned to the next step at each line break in the answer.

20. The storage medium according to claim 15, wherein the controlling displaying includes, in a case in which the length of the duration required by the answerer is longer than a threshold value that is preset corresponding to a step of the answer process, generating data to display a comment that is preset corresponding to the step of the answer process in association with the handwritten input image.
